(19) United States
(12) Patent Application Publication
(10) Pub. No.: US 2009/0037565 A1
(43) Pub. Date: Feb. 5, 2009

(54) ADDRESS MAPPING SCHEME FOR SAS ZONING

(75) Inventors: Mark E. Andresen, Cary, NC (US); Robert B. Basham, Aloha, OR (US); Michael A. Jastad, Portland, OR (US); George O. Penokie, Rochester, MN (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/832,969

(22) Filed: Aug. 2, 2007

(51) Int. Cl. G06F 15/177

(52) U.S. Cl. 709/222

(57) ABSTRACT

The present invention relates to a method for implementing an address mapping scheme within a serial attached SCSI enabled storage area network environment comprising respectively assigning a world wide name of each device comprised within a storage area network to a plurality of switch ports that are comprised within a serial attached SCSI (SAS) switch that is comprised within the storage area network, and assigning each port comprised within the SAS switch to a zone grouping. Further, the respective world wide names of each device that each world wide name will have the right to access is determined, and thereafter a SAS zone permissions table is built comprising the world wide names of each device that each world wide names has the right to access. The world wide names, the SAS switch port assignments, and the SAS zone permission tables are saved to a file or database.

### BACKGROUND OF THE INVENTION

1. Field of the Invention

This invention relates to zoning configuration within storage area network environments, and particularly to address mapping scheme for serial attached SCSI zoning configurations.

2. Description of Background

Typically, address-based zoning on a port swap does not always provide a full solution in the event that it is desired to limit the acceptance of port swapping to local specified boundaries (such as to a particular blade server chasis or a bay). For example, it may be desired to allow for a port swap of disks within a bay or server blades within a chassis, but in the event that the disks are moved to a different bay or chassis it would not be a desirable outcome to have the address-based zoning to move the ports. Further, address-based zoning does not work in the instance that SCSI enclosure services (SES) are managing multiple disks and disks swap. If the address-based zoning automatically adjusts for port swapping this does not allow for the adjustments SES access is required to implement.

### SUMMARY OF THE INVENTION

The shortcomings of the prior art are overcome and additional advantages are provided through the provision of a method for implementing an address mapping scheme within a serial attached SCSI enabled storage area network environment. The method comprises respectively assigning a world wide name of each device comprised within a storage area network to a plurality of switch ports that are comprised within a serial attached SCSI (SAS) switch that is comprised within the storage area network, and assigning each port comprised within the SAS switch to a zone grouping. The method also comprises determining the respective world wide names of each device that each world wide name will have the right to access, building a SAS zone permissions table comprising the world wide names of each device that each world wide name has the right to access, and saving the world wide names, the SAS switch port assignments, and the SAS zone permissions table to a file or database.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A shows a flow diagram illustrating the configuration for implementing a world wide name address-mapping scheme for SAS zoning in accordance with the exemplary embodiment of the present invention.

FIG. 1B shows a world wide name access permission table.

FIG. 2 shows a flow diagram illustrating a method for creating an address-mapping scheme for SAS zoning in accordance with the exemplary embodiment of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the exemplary embodiment of the present invention can be implemented within a conventional computing system environment comprising hardware and software elements. Specifically, the methodologies of the present invention can be implemented to program a computer to accomplish the prescribed tasks of the present invention as described below.

The exemplary embodiment of the present invention allows for a SAS storage area network to configure network zoning by address instead of by a switch port assignment. This particular aspect allows for cable swapping within the network to be managed automatically or with very little intervention from an administrator. Allowing a network administration to set up a port-to-port mapping configuration provides the present solution. The port-to-port mapping configuration is used to create a port based network zone configuration that is based upon current address based mapping definitions. This mapping also comprises any SES access limitations that are required for storage resource operations. Further, boundaries where port swapping is allowed can be delineated to a blade server chasis or the physical boundaries of a bay.

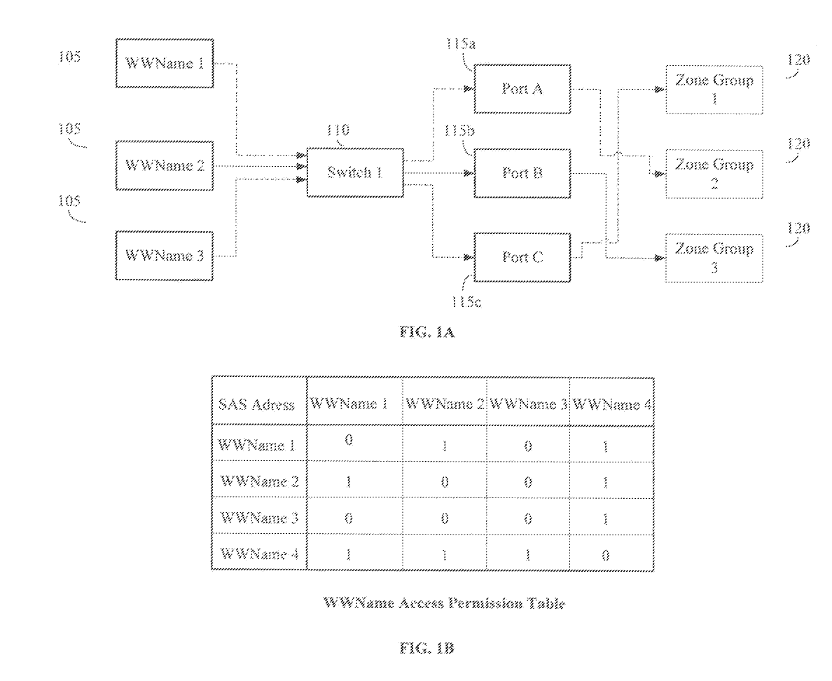

Turning now to the drawings in greater detail, it will be seen that in FIG. 1 there is flow diagram detailing the required elements for implementing an address-mapping scheme for SAS zoning. As shown in FIG. 1A, a plurality of SAS or world wide name addresses 105 is retrieved for each respective device within a storage area network. Also, a SAS switch 110, and the ports 115a, 115b, and 115c comprised within the SAS switch 110 are identified.

Port mapping operations are accomplished as follows. A network administrator retrieves the world wide name SAS Address of each networked device in order to create a network address-mapping scheme. Since SAS zoning does not actually work by listing world wide name SAS Addresses in a zone, each world wide name SAS Address is mapped to the current physical location of its corresponding switch port. For example as shown in FIG. 1A:

WWName 1 is mapped to Switch 1, Port A

WWName 2 is mapped to switch 1, Port B

WWName 3 is mapped to Switch 1, Port B

In order to properly implement SAS zoning, each port 115 must be assigned to a zone group 120. Within the present example for simplicity, each port 115 will be assigned to a singular zone group. However, reductions are possible to combine multiple ports 115 within the same zone groupings that have the same access pattern. As shown in FIG. 1A:

Switch 1, Port A is mapped to Zone Group 2

Switch 1, Port B is mapped to Zone Group 3

Switch 1, Port B is mapped to Zone Group 1

Each set of mapping information shown above is placed into a respective table for ease of reference. Next, a determination is made as to which world wide names 105 respective world wide names will have the authority to access. This determined information is used to construct a permissions table using the current physical port location information, FIG. 1B shows a world wide name access permission table, wherein:

WWName 1 has access to WWName 2 and WWName 4

WWName 2 has access to WWName 1 and WWName 4

WWName 3 has access to WWName 4

WWName 4 has access to WWName 1, WWName 2, and WWName 3

Within the exemplary embodiment of the present invention in the event that a port's 115 world wide name SAS Address changes, then the port 115 is disabled until a decision is made regard to the continued utilization of the port 115. The information contained within three tables above have the capability to provide a sufficient amount of information to rebuild a working storage area comprising the same logical world wide name SAS address access information that was defined for the original storage area network.

Additionally, the world wide name SAS zoning information can be used to set up an actual phy-based zone configuration. In this instance each port 115 is assigned to a world wide name 105. Next, each world wide name 105 is mapped in the permission table to the world wide names of ports 115 it should be able to access. For storage area networks that are larger than 128 ports, the current algorithm can be modified using common k-map reduction techniques to handle more than 120 ports. Further, for each disk drive that is mapped directly to a server, the utilization of a SES controller will be required; wherein SES must be instructed to provide implemented server blades access only to those disks to which it has zoning access.

The tables that are created as described above can subsequently be save within a file or database for access at later time periods or for network access reconfiguration activities. In the event that a network object is moved in such a manner that the network-zoning configuration needs to be re-applied, swapping of a device with a zone can be automated based on policy. For example, if it were served in a place accessible to the switch the network zone configuration could be reapplied to the network based on the new location of the devices, after SES was updated for any moved disks. Such policies that can be implemented with the exemplary embodiment of the present invention including: the automatic application for the moving of disks within a buy, wherein manual procedures are utilized for disks that are moved external to the bay; the automatic application for the moving of server blades within a chasis, wherein manual procedures are utilized in the event that the server blades are move outside the chasis; the automatic application at power-up (cold-swap); and the automatic application in the instance of the recognition of certain types of hardware (e.g., based upon the IEEE assigned address of hardware).

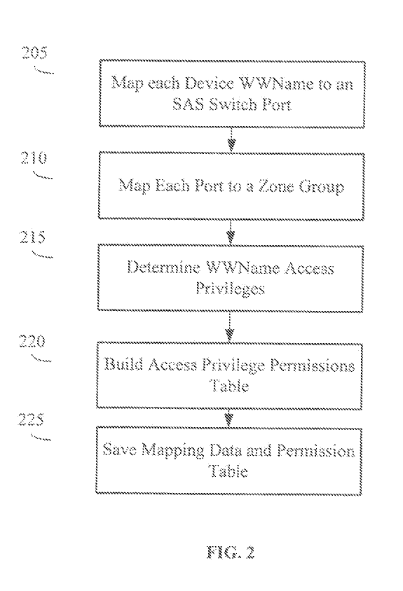

FIG. 2 shows a flow diagram detailing a method for implementing an address-mapping scheme within a serial attached SCSI enabled storage area network environment. At step 205 the world wide names 105 of each device comprised within a storage area network are respectively assigned to a plurality of switch ports 115 that are comprised within a serial attached SCSI (SAS) switch 110 that is comprised within the storage area network. Next, at step 210, each port 115 that is comprised within the SAS switch 110 is assigned to a zone grouping 120. The world wide name of each device that each respective world wide name will have the right to access is determined (step 215). At step 220, a SAS zone permissions table is constructed comprising the world wide names of each device that each world wide name has the right to access. Lastly, at step 225 the world wide names, the SAS switch port assignments, and the SAS zone permissions table are saved to a file or database.

The capabilities of the present invention can be implemented in software, firmware, or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing an address mapping scheme within a serial attached SCSI enabled storage area network environment, the method comprising:
respectively assigning a world wide name of each device comprised within a storage area network to a plurality of switch ports that are comprised within a serial attached SCSI (SAS) switch that is comprised within the storage area network;
assigning each port comprised within the SAS switch to a zone grouping;
determining the respective world wide names of each device that each world wide name will have the right to access;
building a SAS zone permissions table comprising the world wide names of each device that each world wide name has the right to access; and
saving the world wide names, the SAS switch port assignments, and the SAS zone permissions table to a file or database.

2. The method of claim 1, wherein the SAS switch ports that comprise identical access assignments are assigned to the same zone group.

3. The method of claim 2, where in the event that a world wide name assignment to a SAS switch port changes, the port is disabled until the port is assigned to another world wide name.

4. The method of claim 3, where in the event that a device is directly mapped to a host device, the host device is allowed access only to the devices that are comprised within a zone to which the host device has access.

5. A computer program product that includes a computer readable medium usable by a processor, the medium having stored thereon a sequence of instructions which, when executed by the processor, causes the processor to create an address mapping scheme within a serial attached SCSI enabled storage area network environment by:
receiving input in regard to the respective assignment of a world wide name of each device comprised within a storage area network to a plurality of ports that are comprised within a serial attached SCSI (SAS) switch that is comprised within the storage area network;
receiving input in regard to the assignment of each port comprised within the SAS switch to a zone grouping;
receiving input in regard to the determination of the respective world wide names of each device that each world wide name will have the right to access;
building a SAS zone permissions table comprising the world wide names of each device that each world wide name has the right to access; and
saving the world wide names, the SAS switch port assignments, and the SAS zone permissions table to a file or database.

6. The computer program product of claim 5, wherein the SAS switch ports that comprise identical access assignments are assigned to the same zone group.
